(19) United States
(12) Patent Application Publication
(10) Pub. No.: US 2005/0275894 A1
(43) Pub. Date: Dec. 15, 2005

(54) Method of controlling printing apparatus, method of generating receipt print data, program, printer driver, printing apparatus, merchandise sales data processing apparatus and POS system

(76) Inventor: Masahiro Minowa, Hata (JP)

Correspondence Address: HARNESS, DICKEY & PIERCE, P.L.C., P.O. BOX 828, BLOOMFIELD HILLS, MI, 48303, US

(21) Appl. No.: 10/675,858

(22) Filed: Sep. 30, 2003

(30) Foreign Application Priority Data
Oct. 11, 2002 (JP) 2002-298994
Oct. 11, 2002 (JP) 2002-298995

(51) Int. Cl. G06F 15/00

(52) U.S. Cl. 358/1.18; 358/1.15

(57) ABSTRACT

In a method of controlling a printing apparatus which performs printing by adding image data already stored in the printing apparatus to payment transaction print data generated on the basis of input information concerning merchandise sales, a predetermined character string indicating a print position of the image data is retrieved from the payment transaction print data and the predetermined character string is extracted. A line number specified by the extracted predetermined character string is obtained and an image addition setting command is generated on the basis of the line number. The payment transaction print data and the image addition setting command are transmitted to the printing apparatus. Even if a low-speed interface is used as an interface between a PC and the printing apparatus, the image data can be printed rapidly.

### BACKGROUND OF THE INVENTION

1. Field of the Invention

The present invention relates to a method of controlling a printing apparatus (printer) which performs printing by adding already stored image data to payment transaction print data generated on the basis of input information concerning merchandise sales, a method of generating receipt print data, a program, a printer driver, a printing apparatus, a merchandise sales data processing apparatus and a POS (point-of-sale) system.

2. Description of the Related Art

Conventionally, in a POS system utilized in the retail business, such as in supermarkets or convenience stores, a POS terminal includes a host computer which obtains input information concerning merchandise sales and a printing apparatus for printing receipts. As the POS terminal of this kind, typically used is a printing apparatus which receives payment transaction print data generated by the host computer and performs printing on a receipt based on the payment transaction print data (see FIG. 17).

However, in recent years, a printing apparatus capable of printing image data such as logos of stores, for example, other than the payment transaction print data is also known (see Published Unexamined Japanese Patent Application No. 2001-273560).

In a POS terminal which prints such payment transaction print data and image data on an identical receipt, the image data are previously stored in a host computer and, after combining the image data with the payment transaction print data generated in the host computer, the data are transmitted to the printing apparatus. However, in the case where the host computer and the printing apparatus are connected to each other by using a low-speed interface, there was a problem in that data transmission takes time and issuance of a receipt is consequently delayed. Thus, processing efficiency is deteriorated as a whole, which brings about obstacles to business such as by keeping customers waiting.

### SUMMARY OF THE INVENTION

In consideration of the foregoing problem, it is an advantage of the present invention to provide a method of controlling a printing apparatus capable of printing image data rapidly even if a low-speed interface is used as an interface between a host computer and a printing apparatus, and to provide a method of generating receipt print data, a program, a printer driver, a printing apparatus, a merchandise sales data processing apparatus and a POS system.

According to the present invention, there is provided a method of controlling a printing apparatus which prints payment transaction print data generated on a basis of input information concerning merchandise sales with addition of predetermined image data. The method comprises the steps of: obtaining the payment transaction print data; retrieving a predetermined character string indicative of a print position of the image data to be printed from the payment transaction print data; obtaining a line number specified by the retrieved predetermined character string. Preferably, the method further comprises the steps of: generating an image addition setting command based on the obtained line number; and transmitting the payment transaction print data and the image addition setting command to the printing apparatus. The printing apparatus adds the image data to the payment transaction print data based on a result of analysis of the image addition setting command.

According to this method of controlling the printing apparatus, the predetermined character string indicative of the print position of the image data is retrieved from the generated payment transaction print data, and the image addition setting command is generated on the basis of the line number specified by the predetermined character string. The image addition setting command is then transmitted to the printing apparatus together with the payment transaction print data. The printing apparatus adds the image data to the payment transaction print data based on the result of analysis of the image addition setting command and generates data to be printed on a receipt. Consequently, even if a low-speed interface is used as the interface between a host computer and the printing apparatus, the image data can be printed rapidly. Moreover, since the image addition setting command for adding the image data is generated on the part of the host computer, addition setting for the image data can be performed by the host computer without directly operating the printing apparatus. Furthermore, since the print position of the image data is specified by the line number which is one of parameters included in the image addition setting command, the printing apparatus can easily determine the print position and perform the process of adding the image data. Particularly, by setting the predetermined character string to be a character string which is always printed on the receipts (such as “Receipt” and “Total Amount”), it is possible to issue a receipt on which the image data are printed in an appropriate position in accordance with the length of the receipt.

Preferably, the predetermined character string is a start character string indicative of a position to start addition of the image data and, in the step of obtaining the line number, a line number specified by the start character string is obtained.

According to this arrangement, it is possible to add the image data in a region specified by the start character string. In this case, the position to end the addition of the image data may be arranged to be down to the end of the payment transaction data. Thus, it is possible to issue a receipt on which the image data are printed in an appropriate region in accordance with the length of the receipt.

Preferably, the predetermined character string is made up of a start character string indicative of a position to start addition of the image data, and an end character string indicative of a position to end addition of the image data.

According to the above arrangement, the image data can be added to the region specified by the start character string and the end character string as specified in the step of obtaining the line number. In this case, it is also possible to issue a receipt on which the image data are printed in an appropriate region in accordance with the length of the receipt, thereby printing the plurality of images in a manner superposed on the payment transaction information by dividing the receipt into further segments.

Preferably, the printing apparatus has stored therein a plurality of image data files which are files of the image data. The method further comprises the steps of: storing a definition table in which the start character string and the end character string are correlated with image designation data for designating an image data file out of a plurality of image data files stored in the printing apparatus; and obtaining, from the definition table, image designation data which are related to the extracted start character string and the end character string. In the step of generating the image addition setting command, the image addition setting command is generated on the basis of the obtained line number and the image designation data.

According to the arrangement described above, the plurality of image data files are stored in the printing apparatus and the image addition setting command includes a parameter concerning the image designation data for designating one image data file from the plurality of image data files. Thus, it is possible to add various image data by changing the parameter concerning the image designation data. Therefore, various receipts can be generated.

Preferably, the method further comprises the step of setting at least one of the start character string and the end character string.

According to the arrangement described above, since it is possible to set the start character string and/or the end character string for specifying the print region, the print region can be arbitrarily set according to the preference of a user.

Preferably, the method further comprises the step of setting image designation data in which the image designation data are set in correlation with at least one of the start character string and the end character string to be set in the step of setting the character string.

According to the arrangement described above, since the image designation data can be set in association with the start character string and/or the end character string, various receipts can be generated according to a preference of a user.

Preferably, the method further comprises the step of setting the line number in which, in the step of obtaining the line number, setting is made as to which is obtained between the line number in the start character string and the line number which is one line below the start character string, and setting is made as to which is obtained between the line number in the end character string and the line number which is one line above the end character string.

According to the arrangement described above, it is possible to set how to obtain the line numbers for specifying the print region (specifically, whether the print region is specified in a position including target character strings or the print region is specified in a position not including the target character strings). Thus, it is possible to expand the variations of processing to add the image data.

In case the printing apparatus is capable of performing color printing, the method preferably further comprises the step of setting a printing color of the image data, in which the image addition setting command includes a parameter showing the printing color.

According to the arrangement described above, since the color printing is available, it is possible to enhance visibility of the receipt. Moreover, since the image addition setting command includes the parameter indicating the print color, various receipts can be generated by changing the parameter indicating the print color.

According to another aspect of the present invention, there is provided a method of generating receipt print data by adding stored image data to payment transaction print data generated by a host computer based on input information concerning merchandise sales. The method comprises the steps of: storing the image data; obtaining the payment transaction print data from the host computer; obtaining from the host computer an image addition setting command for printing with the image data added; analyzing the image addition setting command to thereby obtain a line number indicating a print position of the image data; and generating the receipt print data for printing with the image data added to the payment transaction print data based on the line numbers.

According to still another aspect of the present invention, there is provided a program for a computer to execute the steps of the above-described method of controlling a printing apparatus or the steps of the above-described method of generating receipt print data.

According to the arrangement described above, it is possible to provide the program capable of printing the image data rapidly even if a low-speed interface is used as the interface between a host computer and the printing apparatus.

According to still another aspect of the present invention, there is provided a printer driver for enabling a computer to execute the steps of the above-described method of controlling a printing apparatus.

According to the arrangement described above, it is possible to provide the printer driver capable of printing the image data rapidly even if a low-speed interface is used as the interface between the host computer and the printing apparatus. Moreover, since the printer driver realizes the foregoing method of controlling a printing apparatus, it is possible to issue a color-graphic-based receipt by using the printing apparatus without changing an application program when the host computer uses a monochrome-text-based application program, for example.

According to still another aspect of the present invention, there is provided a printing apparatus to generate receipt print data by adding stored image data to payment transaction print data generated by a host computer based on input information concerning merchandise sales. The printing apparatus comprises: means for storing the image data; means for obtaining the payment transaction print data from the host computer; means for obtaining from the host computer an image addition setting command for printing with the image data added; means for analyzing the image addition setting command to thereby obtain line numbers indicative of a print position of the image data; and means for generating the receipt print data by adding the image data to the payment transaction print data based on the line numbers.

In the method of generating receipt print data and the printing apparatus, which are described above, the image data are stored in the printing apparatus and the payment transaction print data and the image addition setting command for adding the image data are obtained from the host computer. Thereafter, the image addition setting command is analyzed to obtain the line numbers indicating the print position and the image data are added to the payment transaction print data based on these line numbers. Thus, even if a low-speed interface is used as the interface between the host computer and the printing apparatus, the image data can be printed rapidly. Moreover, since the addition setting command for adding the image data is generated on the side of the host computer, the addition setting for the image data can be performed by the host computer without directly operating the printing apparatus. Furthermore, since the print position of the image data is specified by the line number which is one of parameters included in the image addition setting command, the printing apparatus can easily determine the print region and perform the addition processing of the image data.

Preferably, the printing apparatus further comprises: means for performing color printing by using a primary color and at least one secondary color other than the primary color, wherein the means for performing color printing prints the payment transaction print data in the primary color and the image data in said at least one secondary color(s).

According to the arrangement described above, the payment transaction print data are printed in the primary color and the image data are printed in the secondary color(s). In this way, it is possible to add the image data without making it difficult to read the payment transaction print data. Moreover, since the color printing becomes available, it is possible to enhance visibility of the receipt.

According to still another aspect of the present invention, there is provided a merchandise sales data processing apparatus having: the above-described printing apparatus; and a host computer which controls the printing apparatus by transmitting the payment transaction print data and the image addition setting command to the printing apparatus, wherein the host computer comprises: means for generating the payment transaction print data; means for retrieving predetermined character strings indicative of a print position of the image data by retrieving the predetermined character strings from the payment transaction print data; means for obtaining line numbers specified by the extracted predetermined character strings; means for generating the image addition setting command based on the obtained line numbers; and means for transmitting the payment transaction print data and the image addition setting command to the printing apparatus.

The merchandise sales data processing apparatus extracts the predetermined character string indicating the print position of the image data from the generated payment transaction print data and generates the image addition setting command based on the line number specified by the predetermined character string. Thereafter, the image addition setting command is transmitted to the printing apparatus together with the payment transaction print data. The printing apparatus adds the image data to the payment transaction print data based on the analysis result of the image addition setting command and generates data to be printed on a receipt. Consequently, even if a low-speed interface is used as the interface between the host computer and the printing apparatus, the image data can be printed rapidly. Moreover, since an addition setting command for adding the image data is generated on the side of the host computer, addition setting for the image data can be performed by the host computer without directly operating the printing apparatus. Furthermore, since the print position of the image data is specified by the line number which is one of parameters included in the image addition setting command, the printing apparatus can easily determine the print position and perform addition processing of the image data.

According to yet another aspect of the present invention, there is provided a POS system comprising: the above-described merchandise sales data processing apparatus; and a POS server for managing the merchandise sales data processing apparatus, the POS server being connected to the merchandise sales data processing apparatus through a network.

According to the arrangement described above, it is possible to provide the POS system which is capable of printing the image data rapidly even if a low-speed interface is used as the interface between the host computer and the printing apparatus.

### BRIEF DESCRIPTION OF THE DRAWINGS

The above and other objects and the attendant features of this invention will become readily apparent by reference to the following detailed description when considered in conjunction with the accompanying drawings wherein:

FIG. 1 is a block diagram showing one example of a POS system according to the present invention;

FIGS. 2A and 2B are external perspective views showing a POS terminal included in the POS system according to the present invention;

FIG. 3 is a functional block diagram of a PC according to the present invention;

FIG. 4 is a functional block diagram of a printing apparatus according to the present invention;

FIG. 5 is a control block diagram of the printing apparatus according to the present invention;

FIG. 6 is a view showing one example of a setup screen for setting image data according to the present invention;

FIG. 7 is a flowchart showing one example of payment transaction print data/image addition setting command transmission processing according to the present invention;

FIG. 8 is a flowchart showing one example of receipt print data generation processing according to the present invention;

FIG. 9 is a view showing a definition table and a result of data obtained from payment transaction print data according to the present invention;

FIGS. 10A and 10B are views showing definition tables and results of data obtained from payment transaction print data according to the present invention;

FIGS. 11A and 11B are views showing one example of an image addition setting command code according to the present invention;

FIGS. 12A and 12B are views showing other examples of the image addition setting command code according to the present invention;

FIG. 13 is a view showing one example of image data;

FIG. 14 is a view showing “Print Example 1”, which is one example of a receipt to be generated by the present invention;

FIG. 15 is a view showing “Print Example 2”, which is another example of a receipt to be generated by the present invention;

FIG. 16 is a view showing “Print Example 3”, which is still another example of a receipt to be generated by the present invention; and

FIG. 17 is a view showing an example of generating a receipt according to a conventional example of the present invention.

### DESCRIPTION OF PREFERRED EMBODIMENTS

With reference to the accompanying drawings, a description will now be made about a method of controlling a printing apparatus (printer), a method of generating receipt print data, a program, a printer driver, the printing apparatus, a merchandise sales data processing apparatus, and a POS system according to an embodiment of the present invention. According to the present invention, a host computer extracts predetermined character strings indicative of a print position of image data from payment transaction print data, and generates an image addition setting command for adding the image data to the payment transaction print data based on line numbers specified by the predetermined character strings. Thereafter, in the printing apparatus, the image data are added to the payment transaction print data based on the line numbers obtained from the image addition setting command, and receipt print data to be printed on a receipt are generated.

According to this arrangement described above, even if a low-speed interface is used as an interface between the host computer and the printing apparatus, the image data can be printed rapidly by the printing apparatus. Moreover, the image addition setting command is generated by a printer driver incorporated in the host computer. Thus, it is possible for the printing apparatus to issue a color-graphic-based receipt without changing an application program even if the host computer uses a monochrome-text-based application program, for example. Moreover, the printing apparatus obtains the line numbers from the image addition setting command and the print position can thus be easily specified. There is therefore an effect in that a good-looking receipt can be prepared.

Now, the present invention will be described below by taking a POS system for example. Here, the POS system is used in a shop such as a supermarket or a convenience store, and is arranged to issue a receipt based on input information concerning merchandise sales which is inputted by an operator.

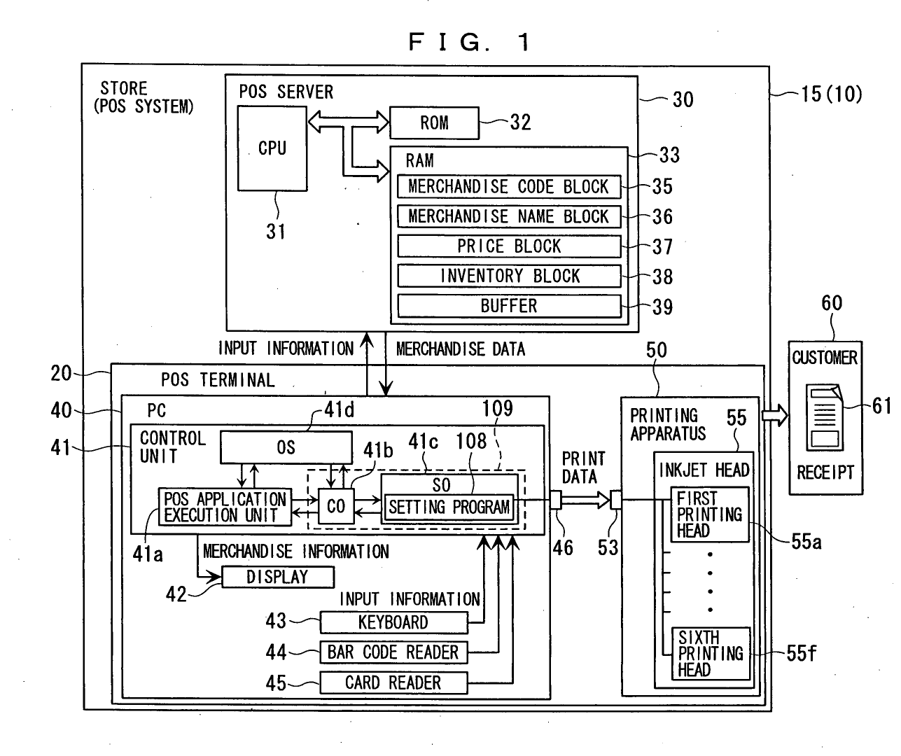

As shown in FIG. 1, a POS system 10 of the present invention is made up of: a plurality of POS terminals 20 (only one POS terminal illustrated in FIG. 1) which are merchandise sales data processing apparatuses to obtain the input information mainly by reading bar codes attached to the merchandise by an operator (user); and a POS server 30 for managing the input information inputted to the POS terminals 20 connected to the POS server 30 through a network.

The POS server 30 includes a control apparatus (a central processing unit (CPU) 31), and memories such as a read-only memory (ROM) 32 and a random access memory (RAM) 33. The POS server 30 processes information stored in a buffer 39 or the like in the RAM 33 in accordance with a control program stored in the ROM 32. In particular, the RAM 33 contains a merchandise master which includes a merchandise code block 35, a merchandise name block 36, a price block 37, an inventory block 38 and the like. The CPU 31 extracts information concerning a merchandise code, a merchandise name and a price out of the merchandise master based on input information transmitted from the POS terminal 20, and generates merchandise data to be printed on a receipt 61 and to be displayed on a display 42 of the POS terminal 20. Here, the “merchandise data” refer to original data for payment transaction print data to be generated by a personal computer (PC) 40. The merchandise data contain merchandise information to be printed on the receipt 61, such as the merchandise name or the price thereof.

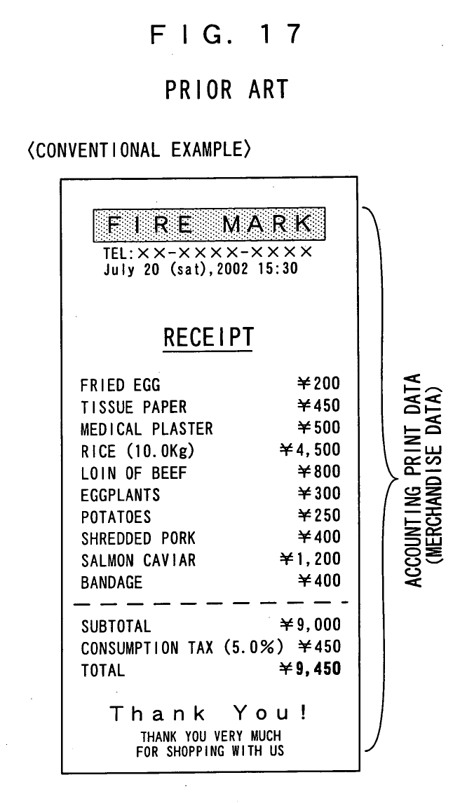

The POS terminal 20 includes the PC 40, which has a POS application execution unit 41a for generating the payment transaction print data (which are data and commands for printing a store name and a telephone number thereof, date of purchase, a message for a customer and the like in addition to the merchandise information; see FIG. 17) to be printed on the receipt 61 by referring to the merchandise data stored in the POS server 30 based on the input information, and for performing payment transaction registration processing such as registration of the inputted data on the POS server 30. The POS terminal 20 also includes a printing apparatus 50 (a receipt printer) for printing the receipt 61 based on the print data. The PC 40 and the printing apparatus 50 are connected to each other through connectors 46 and 53. The PC 40 obtains the input information such as information concerning the merchandise (the merchandise information) and information concerning a customer 60 (customer information) from input with a keyboard 43 or bar code reading with a bar code reader 44. Meanwhile, a card reader 45 reads a credit card or a membership card of the customer 60, whereby the PC 40 obtains information on credit card clearance and information on the member such as a membership number. Moreover, the PC 40 further includes the display 42 for displaying the merchandise information generated on the basis of the merchandise data transmitted from the POS server 30. The display 42 exhibits the price of the purchased merchandise, and the like to the customer 60.

The PC 40 is controlled by a printer driver “OLE for Retail POS” (hereinafter referred to as the OPOS) which operates on an operating system (OS) such as Microsoft Windows (registered trademark). The OPOS provides a POS application execution unit 41a that operates on the OS with an interface which does not depend on models of peripheral devices such as the printing apparatus 50 and the bar code reader 44. The OPOS includes a control object (CO) 41b which corresponds to respective device categories, and a service object (SO) 41c which corresponds to respective device models.

The POS application execution unit 41a generates the payment transaction print data to be printed on the receipt 61 based on the merchandise data transmitted from the POS server 30 and on the input information. The payment transaction print data are delivered through an OS 41d to the CO 41b for the printing apparatus and further delivered from the CO 41b to the SO 41c corresponding to the model of the printing apparatus 50. The SO 41c processes the print data and thereby generates a print command corresponding to command specifications of the printing apparatus 50, and then transmits the print command to the printing apparatus 50. Here, the above-described OPOS is provided to the user as a printer driver 109 in the combined form of the SO 41c and the CO 41b.

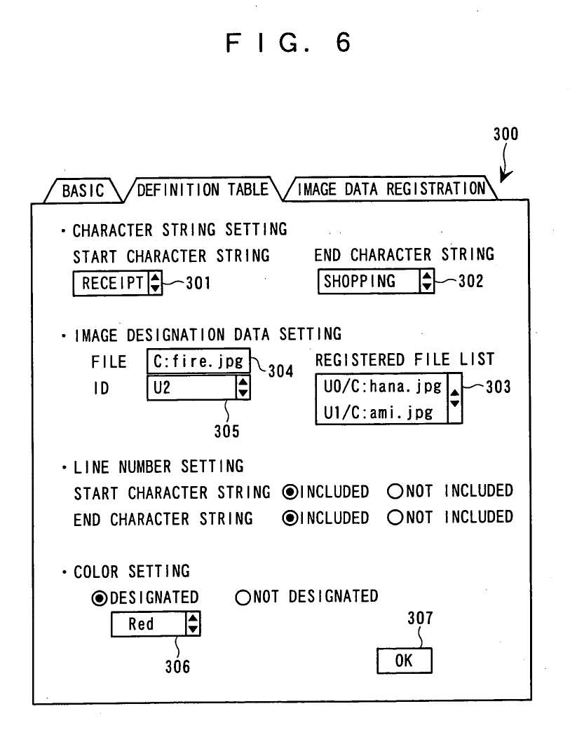

Moreover, an image data setting program 108 which generates the image addition setting command for adding the image data to the payment transaction print data and performs various settings of the image data is installed in the SO 41c. The image data setting program 108 is designed to provide the user with an interface for setting the image data by means of displaying certain setup screens 300 (see FIG. 6) on the display 42. The detailed description for the image data setting program 108 will be made later. Since the image data setting program 108 (utility execution program) is provided by the printer driver 109 as described above, it is possible to perform setting of the image data from the PC 40 without changing the POS application execution unit 41a of the PC 40.

The printing apparatus 50 is an inkjet printing apparatus which adopts an inkjet method for printing. The printing apparatus 50 includes a printing unit 120 having six inkjet heads of first to sixth printing heads 55a to 55f. These inkjet heads 55 are arranged to eject magenta (M) ink, cyan (C) ink, yellow (Y) ink, light magenta (LM) ink, light cyan (LC) ink, and black (K) ink, respectively, so as to perform printing in full colors. Note that the arrangement of the printing heads 55 is not limited to the above. It is possible to increase the number of heads so as to perform printing in more colors; alternatively, it is also possible to decrease the number of heads so as to perform printing in one or two colors only.

It is possible to set the printing apparatus 50 either to a monochrome print mode for printing only with the sixth printing head 55f or to a color print mode for printing with all the printing heads by using a DIP switch or a soft DIP switch (both not illustrated). Accordingly, the PC 40 obtains information on the mode setting and decides whether color information should be contained in the print data to be generated. Therefore, when the printing apparatus 50 is set to the color print mode and the print data contain color information, it is possible to perform two-color or multi-color printing on the receipt 61 based on the above-mentioned conditions. In the following description, it shall be assumed that the printing apparatus 50 is set to the color print mode and that the payment transaction print data are printed in black (K) of the primary color while the image data are printed in designated secondary color(s) other than the primary color (black (K)).

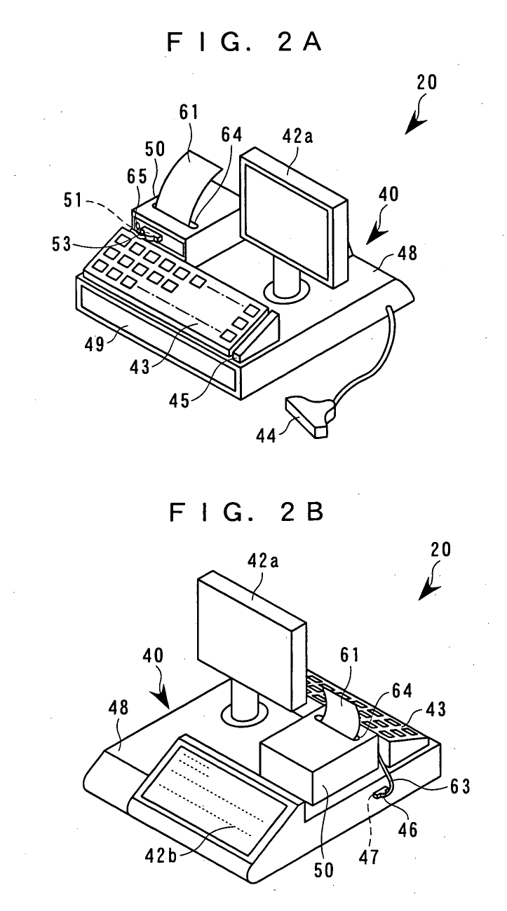

Next, description will be made about the arrangement of the POS terminal 20 with reference to FIGS. 2A and 2B. FIG. 2A is a front perspective view of the POS terminal 20 from the viewpoint of an operator, and FIG. 2B is a rear perspective view of the POS terminal 20 from the viewpoint of a customer. As shown in the drawings, the POS terminal 20 includes the PC 40 whose main part is formed of a box-shaped main body case 48, and the printing apparatus 50 which is disposed on the rear left side of the main body case 48. Here, the printing apparatus 50 is connected to the main body case 48 through a cable. Accordingly, the location of the printing apparatus 50 is not limited to the above, but can be disposed in an arbitrary position within the range allowed by the cable length.

The PC 40 includes a keyboard 43 for allowing the operator to input information such as the merchandise information or the customer information. The keyboard 43 is located on the front upper face of the main body case 48. Moreover, an operator-side display 42a is located on the rear right side of the keyboard 43 so as to allow the operator to confirm the input information. In addition, a cash drawer 49 is housed in the main body case 48. The bar code reader 44 for reading a bar code, which is either attached to or printed on the merchandise, is provided on the right side face of the main body case 48, and an interface 47 to be connected to the printing apparatus 50 is provided on the left side face thereof. Moreover, a card reader slot 45 is formed on the right side of the keyboard 43 for reading a credit card presented by the customer 60. Furthermore, a customer-side display 42b is located on the rear side of the main body case 48 so as to allow the customer 60 to confirm the merchandise information and the like. Here, the setup screens (see FIG. 6) for setting the image data are displayed on the above-described operator-side display 42a. Accordingly, the operator performs the setup operation while confirming the setup screens.

An operation indicator lamp 65 and an interface 51 are located on the front side of the printing apparatus 50. The interface 51 and the interface 47 provided on the PC 40 are connected to each other through a cable 63 and the connectors 46 and 53. A receipt outlet 64 for discharging the printed receipt 61 is formed on an upper face of the printing apparatus 50.

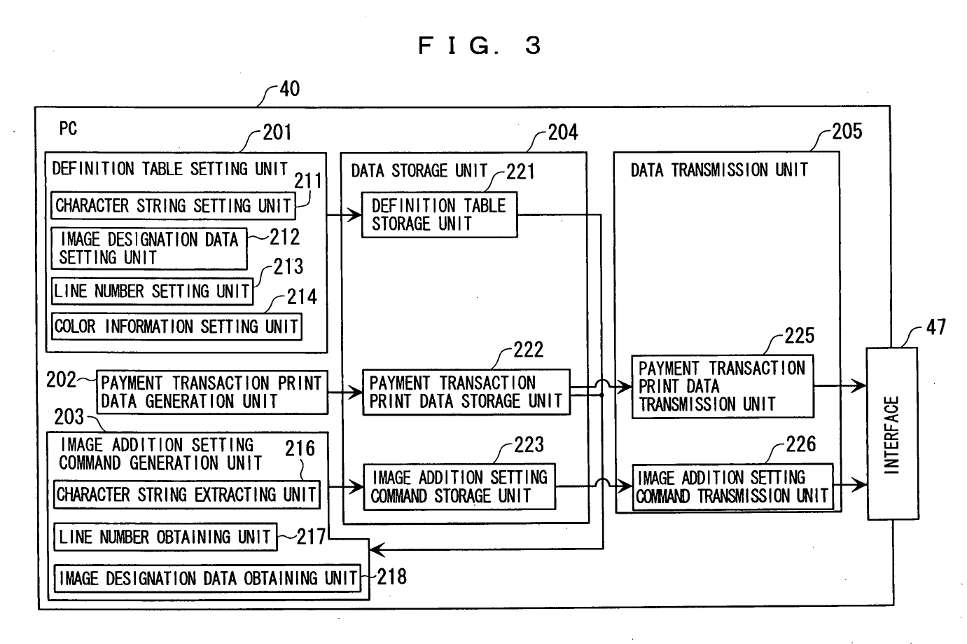

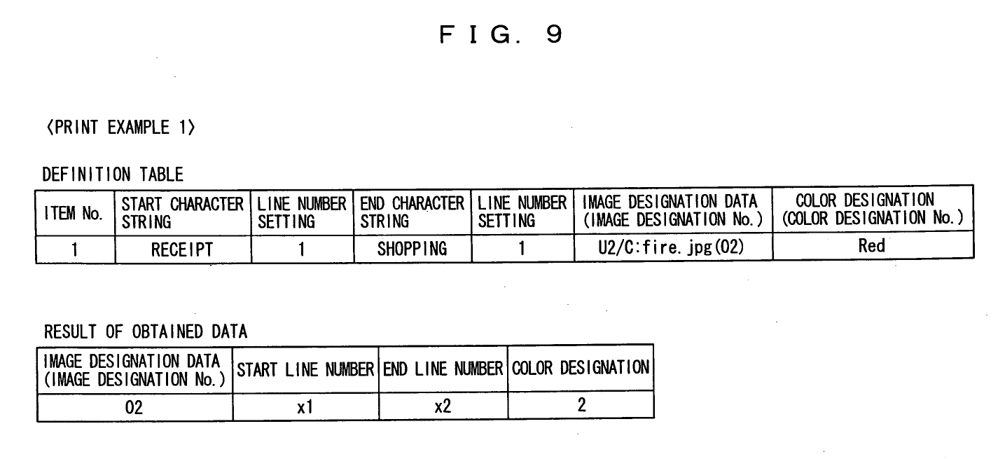

Next, a description will be made about a control arrangement of the PC 40 with reference to a functional block diagram in FIG. 3. The PC 40 includes: a definition table setting unit 201 for setting a definition table (see FIG. 9 and the like) that is a reference table for generating an image addition setting command; a payment transaction print data generation unit 202 for generating payment transaction print data; an image addition setting command generation unit 203 for generating the image addition setting command; a data storage unit 204 for storing various data, the data storage unit including a definition table storage unit 221, a payment transaction print data storage unit 222 and an image addition setting command storage unit 223; and a data transmission unit 205 for transmitting the payment transaction print data and the image addition setting command through the interface 47, the data transmission unit including a payment transaction print data transmission unit 225 and an image addition setting command transmission unit 226. Moreover, the definition table setting unit 201 and the image addition setting command generation unit 203 are mainly realized by the printer driver 109.

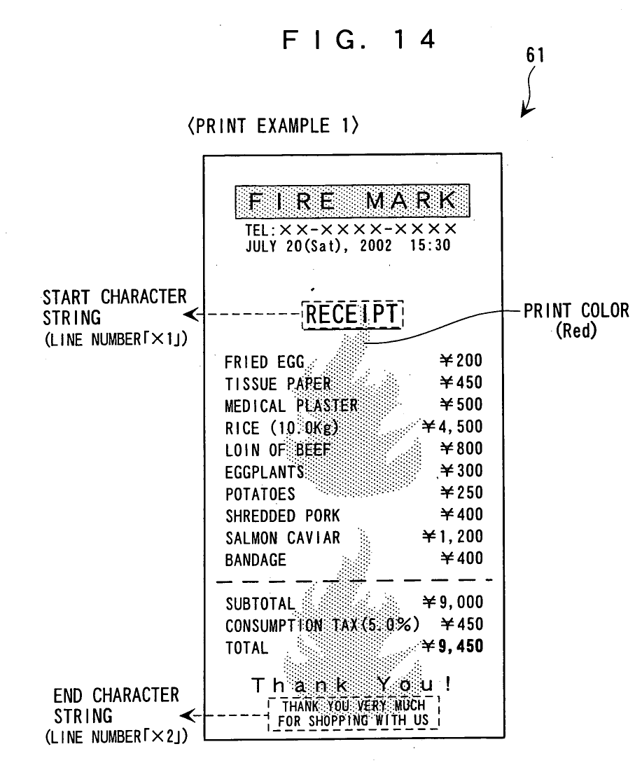

The definition table setting unit 201 is executed by the image data setting program 108 provided by the printer driver 109. Here, the definition table setting unit 201 includes: a character string setting unit 211 for setting predetermined character strings (a start character string and an end character string (see FIG. 14 and the like)) which indicate a print position of image data; an image designation data setting unit 212 for setting image designation data (file names and the like) for designating image data to be added; a line number setting unit 213 (to be described later in detail) for setting patterns of obtaining line numbers which specify the print position of the image data; and a color information setting unit 214 for setting a print color of the image data. The above-described items to be set in the definition table setting unit 201 are set by the user who inputs the necessary items in the setup screen 300 (see FIG. 6). The inputted information is stored in the memory such as the RAM and is rewritable according to a need.

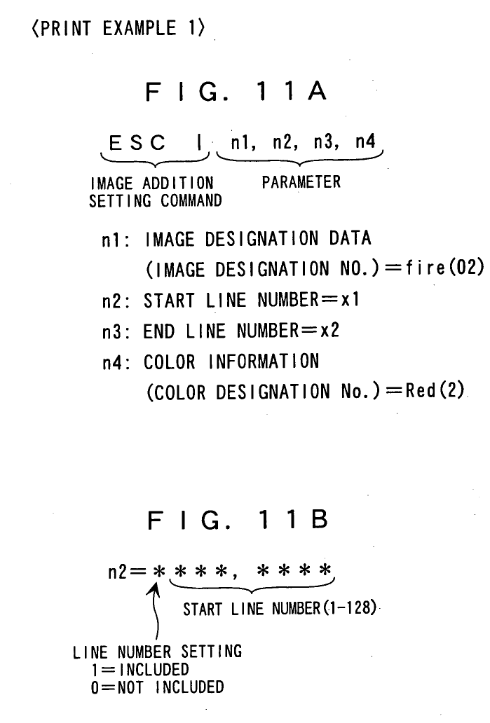

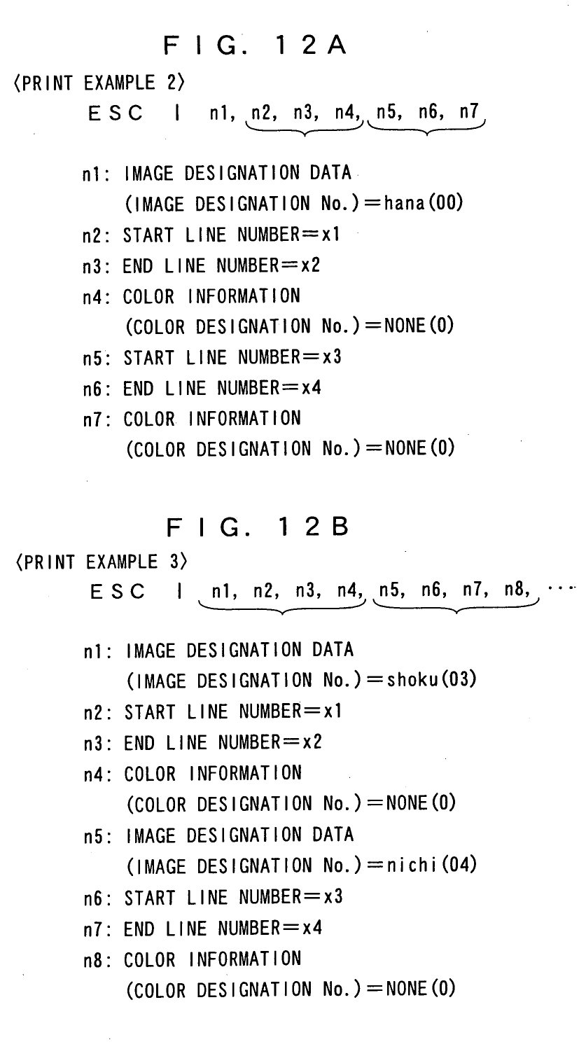

The image addition setting command generation unit 203 includes: a character string retrieving unit 216 for retrieving predetermined character strings by searching or retrieval through the payment transaction print data; a line number obtaining unit 217 for obtaining the line numbers specified by the predetermined character strings; and an image designation data obtaining unit 218 for obtaining the image designation data associated with the predetermined character strings from the definition table. The image addition setting command generation unit 203 generates image addition setting commands “ESC I n1, n2, n3 . . . ” as shown in FIGS. 11 and 12. The arrangement of the image addition setting command will be described later.

According to the above-described arrangement, the PC 40 extracts the predetermined character strings out of the payment transaction print data generated by the payment transaction print data generation unit 202 in accordance with the definition table set by the definition table setting unit 201. Based on the line numbers specified by the predetermined character strings and the image designation data associated with the predetermined character strings, the image addition setting command generation unit 203 generates the image addition setting command. Thereafter, the data transmission unit 205 transmits the generated payment transaction print data and the image addition setting command to the printing apparatus 50.

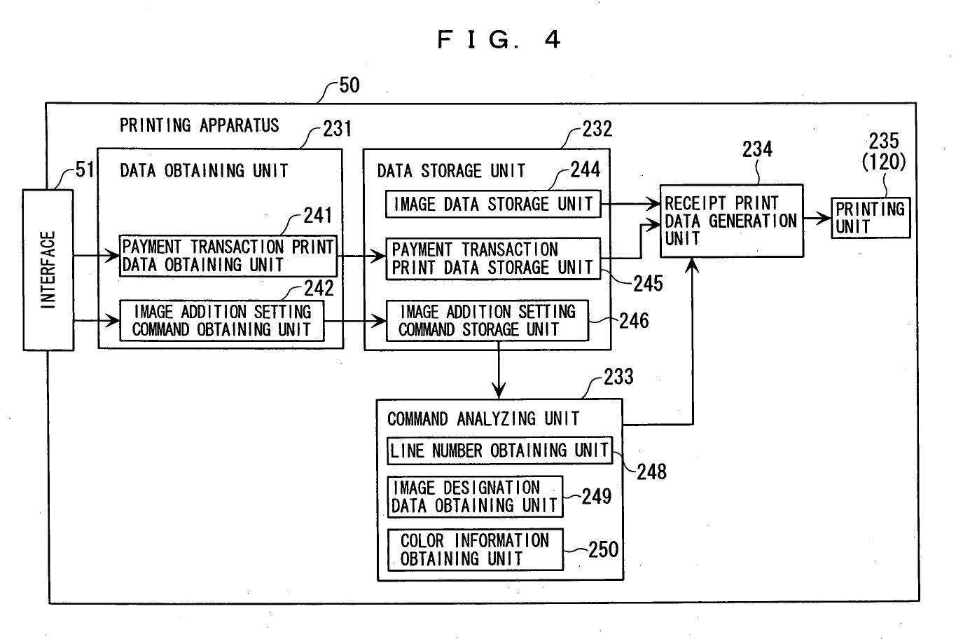

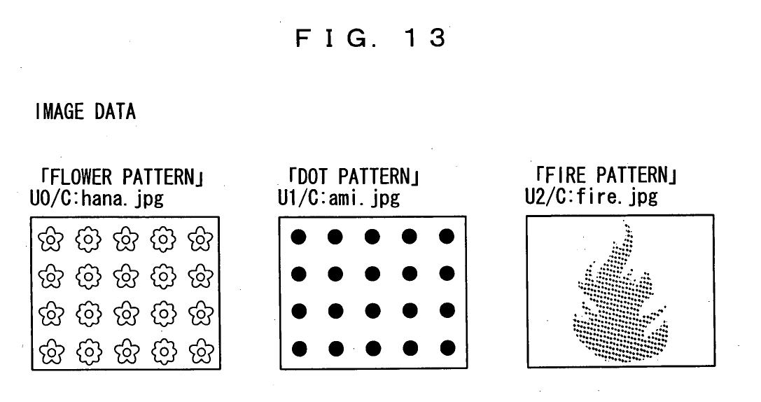

Next, a description will be made about a control arrangement of the printing apparatus 50 with reference to a functional block diagram in FIG. 4. The printing apparatus 50 includes: a data obtaining unit 231 for obtaining the payment transaction print data and the image addition setting command from the PC 40 through the interface 51; a data storage unit 232 for storing the obtained data and a plurality of image data files (see FIG. 13); a command analyzing unit 233 for analyzing the image addition setting command transmitted from the PC 40; a receipt print data generation unit 234 for generating receipt print data to be printed on the receipt 61; and a printing unit 235 for printing the receipt based on the receipt print data.

The data obtaining unit 231 includes a payment transaction print data obtaining unit 241 and an image addition setting command obtaining unit 242 and transmits data to a payment transaction print data storage unit 245 and an image addition setting command storage unit 246, respectively. However, the payment transaction print data and the image addition setting command are actually transmitted at the same time, and the image addition setting command is extracted from the payment transaction print data for performing analyzing processing. Here, in order to facilitate the explanation, the payment transaction print data and the image addition setting command are shown to be obtained and stored separately from each other. Therefore, the payment transaction print data are assumed to be constituted by data and commands for printing the merchandise data, from which the image addition setting command is removed.

The data storage unit 232 includes an image data storage unit 244, a payment transaction print data storage unit 245 and an image addition setting command storage unit 246. Here, the image data storage unit 244 has stored therein in advance a plurality of image data files. The plurality of image data files are obtained in the following manner. Specifically, data read with a scanner and the like by the PC 40 and data prepared by a drawing software are registered in the setup screen 300 executed by the image data setting program 108 (see “image data registration” tab in FIG. 6), and the data are transmitted to the printing apparatus 50 and stored in the image data storage unit 244. Here, the image data files are arranged to be rewritable to meet the needs of the user.

The command analyzing unit 233 includes: a line number obtaining unit 248 for obtaining the line numbers by analyzing the image addition setting command transmitted from the PC 40; an image designation data obtaining unit 249 for similarly obtaining the image designation data (file names, image designation Nos. and the like) from the image addition setting command; and a color information obtaining unit 250 for similarly obtaining color information indicating a print color of the image data from the image addition setting command. The obtained information is stored in a RAM 144 to be described later.

According to the above-described arrangement, the printing apparatus 50 obtains the payment transaction print data and the image addition setting command by operating the data obtaining unit 231 and, by analyzing the image addition setting command by the command analyzing unit 233, the printing apparatus 50 obtains the line numbers, the image designation data and the color information. Furthermore, based on the above-described information, the receipt print data generation unit 234 adds the image data to the payment transaction print data and thus the receipt print data are generated.

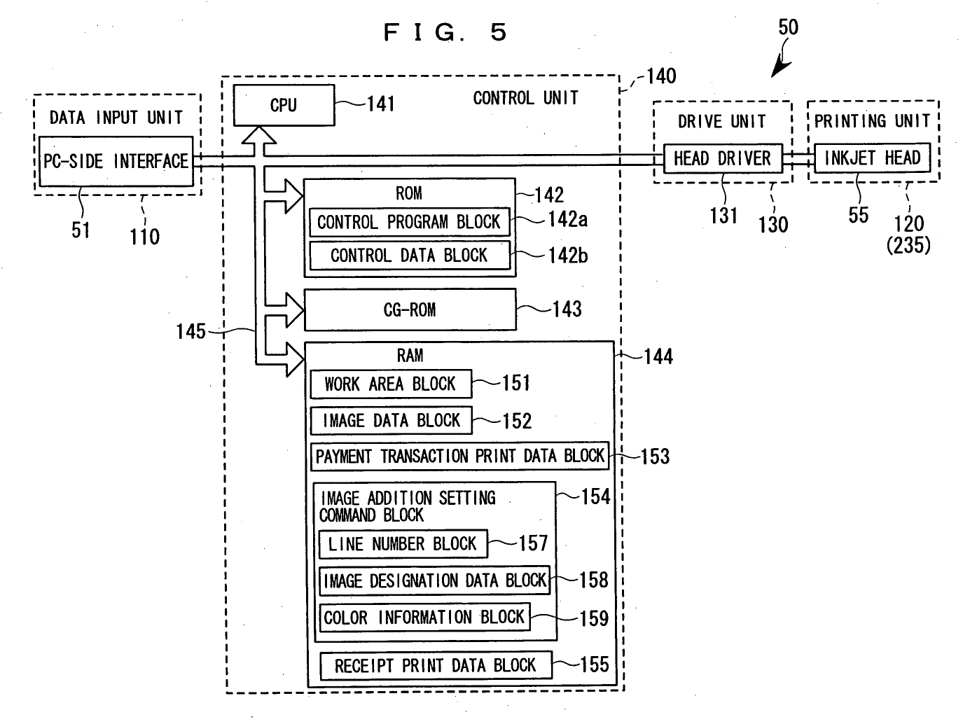

FIG. 5 is a control block diagram of the printing apparatus 50. As shown in the drawing, the printing apparatus 50 includes: a data input unit 110 for inputting the image addition setting command and the payment transaction print data from the PC 40, the data input unit 110 having the interface 51; a printing unit 120 having the six inkjet heads 55 arranged to eject various different colors of ink to thereby perform color printing; a drive unit 130 for driving the inkjet heads 55, the drive unit 130 having a head driver 131; and a control unit 140 for controlling the entire printing apparatus 50.

The control unit 140 includes the CPU 141, a ROM 142, a CG-ROM 143 and the RAM 144, which are mutually connected by using an internal bus 145. The ROM 142 includes a control program block 142a for storing a control program to be processed by the CPU 141, and a control data block 142b for storing control data containing various tables. The CG-ROM 143 stores font data of characters to be printed and outputs relevant font data when a code for specifying the character is given thereto.

The RAM 144 includes: various work area blocks 151 to be used as flags and the like; an image data block 152 for storing a plurality of image data files; a payment transaction print data block 153 for storing the payment transaction print data transmitted from the PC 40; an image addition setting command block 154 for storing information concerning the analysis result of the image addition setting command; and a receipt print data block 155 for storing the receipt print data generated by adding the image data to the payment transaction print data. The RAM 144 is used as a work area for the control processing. Moreover, the RAM 144 is always backed up so that the RAM 144 retains the stored data even if electric power is cut off.

The image addition setting command block 154 includes a line number block 157, an image designation data block 158 and a color information block 159, for storing the line numbers, the image designation data and the color information, respectively, which are obtained as a result of analyzing the image addition setting command. The image addition setting command block 154 stores the information obtained by the respective units of the command analyzing unit 233 (see FIG. 4).

The internal bus 145 is also connected to the data input unit 110 and to the drive unit 130 as well. Accordingly, the input data (such as the image addition setting command or the payment transaction print data) are retrieved from the interface 51 (see FIG. 4), and forward output data (such as the receipt print data) outputted from the CPU 141 and the like and a control signal to the drive unit 130 (the head driver 131).

Moreover, with the above-described arrangement, the CPU 141 inputs various signals, data and the like from the respective units in the printing apparatus 50, processes the various data and the like in the RAM 144, and outputs the various signals, data and the like to the respective units, based on the control program stored in the ROM 142. The CPU 141 further generates the receipt print data by adding the image data to the payment transaction print data in accordance with the analysis result obtained by analyzing the image addition setting command, and then performs printing based on the receipt print data. In this way, the CPU 141 controls the entire printing apparatus 50.

Here, the interface 51 and the interface 47 provided on the PC 40 may adopt various ports, including, those which support serial data transmission such as the RS-232 standard, those which support parallel data transmission such as the Centronics standard, those which support network connection such as 10Base-T Ethernet (trademark) or those which support a data transmission standard such as USB.

When a drive voltage level of internal transistor-transistor logic (TTL) of the PC 40 is different from a drive voltage level inside the printing apparatus 50, it is preferable that the interface 51 and the interface 47 severally include driver circuits for performing level conversion. According to the arrangement described above, it is possible to convert a signal level easily.

Next, a description will be made about the processing of setting the image data with reference to FIG. 6. The setting of the image data is performed by executing the image data setting program 108 (see FIG. 1) in the PC 40. Specifically, when the image data setting program 108 is started, the setup screen as shown in FIG. 6 is displayed on the operator-side display 42a and the setting is performed by the operator by inputting various information thereto.

As shown in FIG. 6, on the setup screen 300, the various information for setting the image data can be set separately on several screens, and the operator (user) performs the setting by opening a desired setup screen. When the setup screen of the first tab “basic” is opened, a width size of the receipt 61, a print density of the image data, a print quality and the like can be set. The above-described contents are approximately the same as those of a normal print setting utility and thus description thereof will be omitted herein. Moreover, when the setup screen of the third tab “image data registration” is opened, image data as shown in FIG. 13 can be registered. Regarding the above-described setup screen, a normal registration method can also be used and description thereof will thus be omitted. Therefore, here, a description will be given only of the setup screen of the tab “definition table.”

As shown in FIG. 6, on the setup screen 300 of “definition table”, first, predetermined character strings are set. The predetermined character strings include a start character string and an end character string. The former indicates a position at which the addition of image data starts and the latter indicates a position at which the addition of the image data ends. The operator may select the start character string and the end character string out of a list of already registered character strings by using up/down icons of a start character string setting field 301 and an end character string setting field 302, or may enter the character strings directly in the respective setting fields 301 and 302. Here, it shall be assumed that the term “receipt” is set as the start character string and the term “shopping” is set as the end character string.

In the above-described embodiment, an example was shown in which the image is overlapped or superposed on the region as specified by the start character string and the end character string. It is, however, possible to designate only the start character string and make the end of the image coincide with the end position of printing the payment transaction information.

Subsequently, the image designation data is set. In the setting of the image designation data, when the operator selects one file from a registered file list 303, a file to be the image data is designated and is inputted in a file setting field 304. Moreover, by selecting a registered ID in an ID field 305, the operator can also designate the file. Here, as shown in FIG. 13, three image files are registered as “image data” and it is assumed that one image data can be selected from these files. In this setting operation, it is assumed that a “fire pattern (ID:U2)” is selected.

Subsequently, the line numbers are set. Here, it is possible to set, as the line numbers for specifying the print region, which one of the line number of the start character string and a line number of a character string immediately therebelow shall be obtained, and which one of the line number of the end character string and a line number of a character string immediately thereabove shall be obtained. Specifically, it is possible to set whether the print region is specified in a position including object (or target) character strings or the print region is specified in a position not including the object character strings. Here, it is assumed that a region from the position (line) “including” the start character string to the position (line) “including” the end character string is specified as the print region.

Subsequently, the color setting is performed. Here, first, it is set whether or not color designation is performed. Accordingly, when the operator checks a “designated” field of the color setting, a print color for printing the image data is set in a color setting field 306.

Here, since it is previously set that the payment transaction print data are printed in the primary color “K (black)”, it is possible to set the image data to be printed in a print color (a secondary color) other than “K (black).” Therefore, in a printing apparatus which performs two-color printing by using only “K (black)” and “R (red)”, for example, when print data are printed in the primary color “K (black)”, image data will consequently be printed in a secondary color “R (red).” In this way, since the print data are printed in the primary color and the image data are printed in the secondary color, it is possible to add the image data without making it difficult to read characters to be printed and the like of the print data due to the image data. In this setting operation, it is assumed that the print color “Red” is selected.

When a “not designated” field of the color setting is checked, the image data will be printed in a previously set print color (for example, a theme color of a store and the like). However, in case where, e.g., the image data are registered in color, the image data may be printed in the registered color. When the setting of the above-described contents is completed, the operator clicks on an “OK” button 307. Accordingly, information that has been set regarding the “definition table” is stored in the memory such as the RAM in the PC 40.

Here, with reference to FIGS. 9 and 14, a description will be made about a definition table according to the foregoing setting and a print result. As shown in FIG. 9, in the definition table, an item No. is attached to information set by the above-described series of operations. Here, it is shown that only one item (item No. 1) is set. Moreover, the term of “receipt” is set as the start character string, the term of “shopping” is set as the end character string, and the line numbers of the respective character strings are set to be “1.” This shows that the print region is specified by the position (line) “including” the object character strings. When the print region is specified by the position “not including”, the line numbers of the respective character strings are set to be “0” In other words, the line number of the line immediately below the start character string is obtained when the object character string: is the “start character string”, and the line number of the line immediately above the end character string is obtained when the object character string is the “end character string.”

Although “U2/C:fire.jpg” is set as the image designation data, the image designation data may be stored under a file name “fire” on the table. Moreover, instead of the file name, the image designation data may be stored by using a serial number attached to each of image data files or a numerical value attached on the basis of a predetermined rule. Here, it is assumed that, based on “U2” that is an ID, an image designation No. “02” is stored.

Moreover, although “Red” is set in the color designation, instead of the color name, the designated color may be stored on the table by using a color designation No. attached to every color or a numerical value attached on the basis of a predetermined rule. Here, it is assumed that the color designation No. attached to every color (Red is “2”) is stored.

Now, a result of data obtained when the above-described information is stored in the definition table and when the payment transaction print data contain the start character string “receipt” and the end character string “shopping” is shown in FIG. 9. Specifically, in this case, there are obtained data indicating that “the image data of the image designation No. 02 is printed in the color designation No. 2 in the print region from the line number “x1” to the line number “x2”.” The line numbers “x1” and “x2” are line numbers which indicate the lines including the start character string “receipt” and the end character string “shopping”, respectively.

Accordingly, a print result obtained as a result of obtaining the data as described above is <Print Example 1> shown in FIG. 14. As shown in FIG. 14, on the receipt 61, the image data “U2/C:fire.jpg” (the fire pattern; see FIG. 13) is attached to the payment transaction print data (see FIG. 17), and the print color thereof is “Red.” Moreover, the print region is from the line number “x1” including the start character string “receipt” to the line number “x2” including the end character string “shopping.” Furthermore, as shown in FIG. 14, the image data are repetitively printed in accordance with the length from the line including the start character string to the line including the end character string.

When only one of the start character string and the end character string is included in the payment transaction print data, that is, when not both of the start character string and the end character string are included therein, the print region cannot be specified. Thus, the image data are not added. However, the following alternative ways are also possible depending on a design change. Namely, when any one of the start character string and the end character string is extracted, the image data are added in a manner to cover x lines downward from the start character string, or in a manner to cover down to the end line in the receipt from the start character string, or in a manner to cover y lines upward from the end character string or up to the start line in the receipt from the end character string.

As described above, according to the present invention, the print region of the image data is specified by the line number or numbers which is or are one of parameters included in the image addition setting command. Thus, the printing apparatus 50 can easily determine the print region and perform the addition processing of the image data. Particularly, since the predetermined character strings are character strings which are always printed on the receipt (for example, “receipt”, “total amount” and the like), it is possible to issue the receipt 61 on which the image data are printed in an appropriate position according to the length of the receipt.

Next, with reference to FIGS. 11A and 11B, a description will now be made about an image addition setting command generated on the basis of the result of the obtained data shown in FIG. 9. FIG. 11A shows an arrangement of the image addition setting command. In the drawing, “ESC I” represents an image addition setting command code, and “n1, n2, n3, n4” subsequent thereto represent parameters (a command called an ESC sequence is generally used). Each of the parameters includes 1 byte (8 bits), wherein “n1” indicates the image designation No. and represents “02” in the case of <Print Example 1>. Further, “n2” and “n3” indicate the start line number and the end line number and represent “x1” and “x2” in the case of <Print Example 1>. Still furthermore, “n4” indicates the color information (the color designation No.) and represents “2” in the case of <Print Example 1> (see FIG. 9).

In addition, as shown in FIG. 11B, in the parameter “n2” indicating the start line number, the first one bit among the eight bits represents the line number setting (see FIG. 9) and indicates “1” when the line numbers are included and “0” when the line numbers are not included. Moreover, the remaining seven bits represent the start line number (the first line to the 128^{th} line). The parameter “n3” indicating the end line number has a similar arrangement. The number of bits included in each parameter and the order of parameters can be changed accordingly.

As described above, according to the present invention, a dedicated (or an exclusively used) command for adding the image data can be set as the image addition setting command and various information can be simultaneously transmitted as the parameters together with the payment transaction print data. Thus, the printing apparatus 50 which has received the information and data can easily perform the addition processing of the image data (processing of generating the receipt print data) without interfering with the print processing and the like.

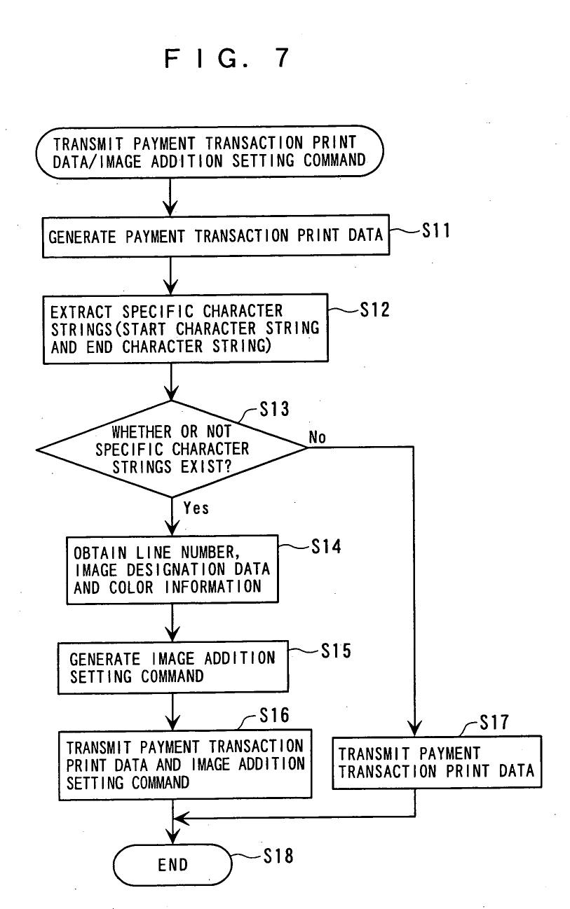

Next, with reference to a flowchart of FIG. 7, a description will be made about the transmission processing of payment transaction print data/image addition setting command in PC 40. The PC 40 obtains input information concerning the merchandise from input with the keyboard 43 or bar code reading with the bar code reader 44 and generates payment transaction print data based on the input information (S11). Thereafter, the PC 40 searches through the payment transaction print data and extracts predetermined character strings (a start character string and an end character string) included in the payment transaction print data (S12).

In this case, as described above, the predetermined character strings are previously set and stored in a definition table. When the predetermined character strings (in the case of <Print Example 1>, the start character string “receipt” and the end character string “shopping”) are extracted (S13: Yes), line numbers specified by the predetermined character strings and image designation data and color information, which are stored as associated with the predetermined-character strings, are obtained (S14; see FIG. 9). Thereafter, an image addition setting command is generated from the obtained result (S15; see FIG. 11A), the image addition setting command is transmitted together with the payment transaction print data to the printing apparatus 50 (S16) and the processing is finished (S18). When the predetermined character strings are not extracted (S13: No), no image addition setting command is generated and only the payment transaction print data are transmitted to the printing apparatus 50 (S17). The above-described character strings shall preferably be terms or words which have meanings. However, if a special single letter has a meaning of its own, it may also be used.

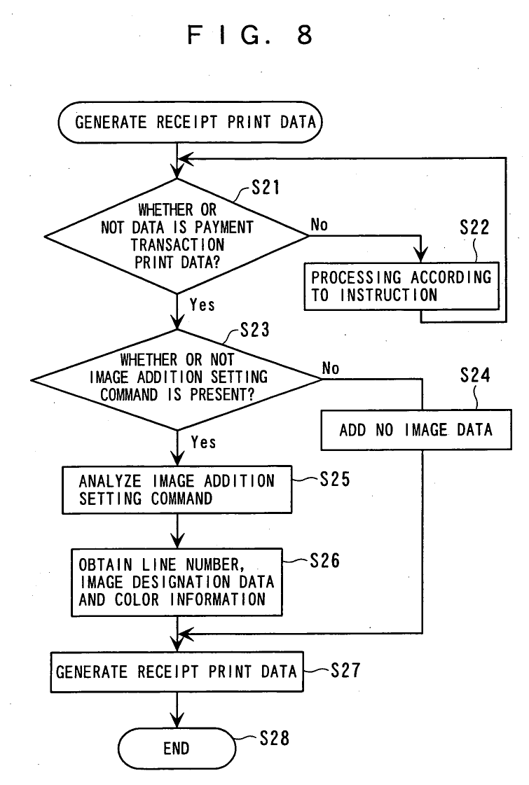

Next, with reference to a flowchart of FIG. 8, a description will be made about the processing of generating receipt print data in the printing apparatus 50, which follows the above-described transmission processing of payment transaction print data/image addition setting command in the PC 40. Upon obtainment of the payment transaction print data from the PC 40 (S21: Yes), the printing apparatus 50 judges whether or not the image addition setting command is transmitted together with the payment transaction print data (S23). When the obtained data are not the payment transaction print data (S21: No), processing according to the instruction is performed (S22). Moreover, when the image addition setting command is not transmitted (S23: No), the addition processing of the image data is not performed (S24) and the payment transaction print data are set to be the receipt print data as it is (S27).

When the image addition setting command is transmitted together with the payment transaction print data (S23: Yes), the image addition setting command is analyzed (S25) and the line numbers (the start line number and the end line number), the image designation data (the image designation No.) and the color information (the color information No.) are obtained (S26; see FIG. 11A). Thereafter, the receipt print data are generated by adding (superposing) the image data to the payment transaction print data based on the obtained information (S27), and the processing is finished (S28).

As described above, according to the present invention, by searching or retrieving through the payment transaction print data generated by the PC 40, the predetermined character strings for specifying the print position of the image data, i.e., the substantial print position of the image data on the receipt, are extracted, and the image addition setting command is generated on the basis of the line numbers specified by the predetermined character strings. Thereafter, the PC 40 transmits the image addition setting command to the printing apparatus 50 together with the payment transaction print data. The printing apparatus 50 adds the image data to the payment transaction print data based on the image addition setting command and generates the receipt print data for printing on the receipt. Namely, with the arrangement described above, it is possible to print the image data rapidly even if a low-speed interface is used as an interface between the PC 40 and the printing apparatus 50. Moreover, since the addition setting command for adding the image data is generated on the part of the PC 40, it is possible to set the image data by the PC 40 without directly operating the printing apparatus 50.

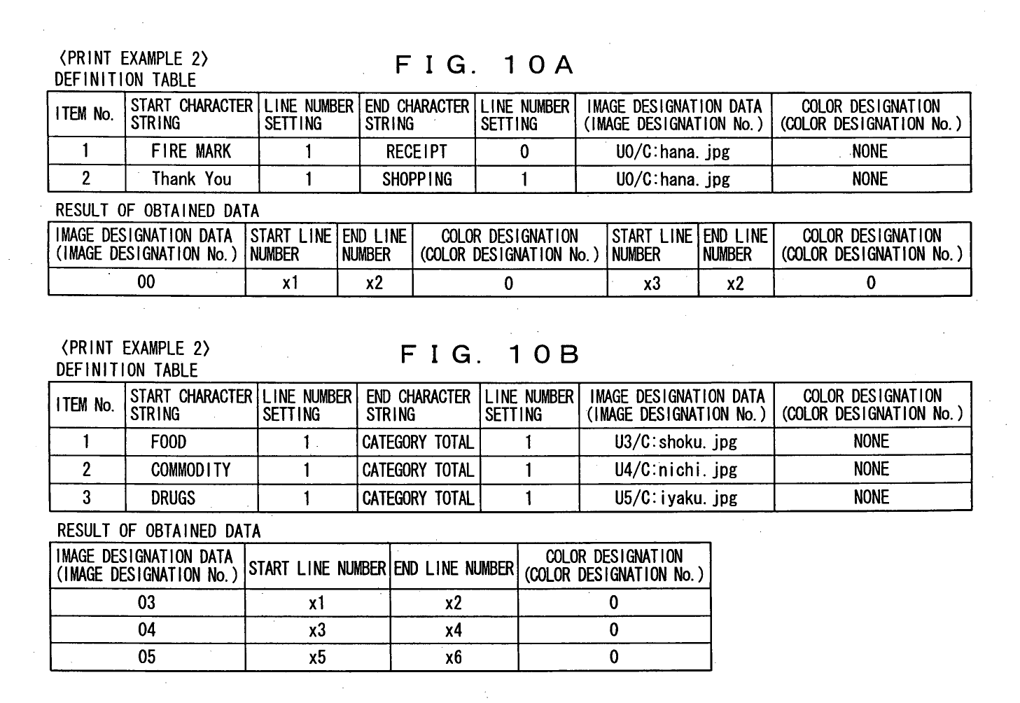

Here, by enumerating several examples, a description will be given about the print examples of other image data. FIGS. 10A, 12A and 15 show a definition table, a result of data obtainment, an image addition setting command and a print result in <Print Example 2>. As shown in FIG. 10A, in the definition table, two items designating the same image data “U0/C:hana.jpg” (a flower pattern) are stored. In this case, as shown in FIG. 10A, the result of obtained data has a format in which two sets of start line numbers, end line numbers and color designations are associated with each other for one image designation data. Accordingly, the same image data are printed in two print regions. Thus, as shown in FIG. 12A, in the image addition setting command, parameters (“n2, n3, n4” and “n5, n6, n7”) indicating the start line number, the end line number and the color information are added as a set after the parameter “n1” indicating the image designation data.

In <Print Example 2>, since the line number setting for the end character string “receipt” is “0” (see FIG. 10A), the first bit representing the line number setting in the parameter “n3” becomes “0,” (see FIG. 11B). Therefore, the line including the end character string “receipt” is not included in the print region, and up to the line immediately above the line including the end character string “receipt” is specified as the print region.

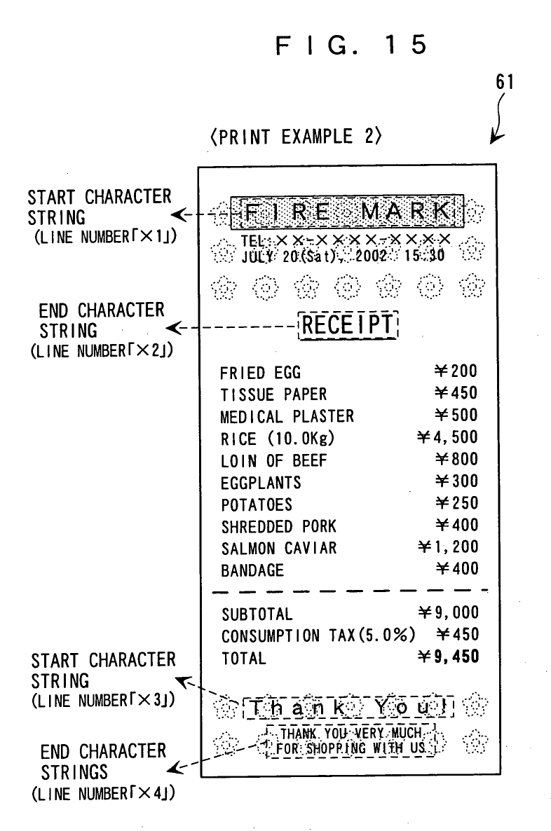

Accordingly, the print result in the case of transmitting the image addition setting command shown in FIG. 12A is shown in FIG. 15. As shown in FIG. 15, the image data (the flower pattern) are printed in two print regions. In the first print region (the print region specified by the start line number “x1” and the end line number “x2”), the image data are printed from the line number “x1” to the line number “x2-1.” In the second print region (the print region specified by the start number “x3” and the end line number “x4”), the image data are printed from the line number “x3” to the line number “x4.”

As described above, when a plurality of predetermined character strings are extracted for the same image data as shown in <Print Example 2>, the addition setting of the image data can be performed by using the image addition setting command with a simpler arrangement.

Next, FIGS. 10B, 12B and 16 show a definition table, a result of data obtainment, an image addition setting command and a print result in <Print Example 3>. As shown in FIG. 10B, in the definition table, three items are stored, in which respective start character strings and end character strings are associated with difference image data (“U3/C:syoku.jpg”, “U4/C:nichi.jpg” and “U5/C:iyaku.jpg”). In this case, as shown in FIG. 10B, the result of obtained data has a format in which start line numbers, end line numbers and color designations are associated with the respective image designation data, respectively. Thus, as shown in FIG. 12B, in the image addition setting command, parameters indicating the image designation data, the start line numbers, the end line numbers and the color information (“n1, n2, n3, n4” and “n5, n6, n7, n8” . . . ) are added as a set.

In <Print Example 3>, the three items are stored in the definition table. However, the three items have different start character strings and the same end character string “category total.” In this case, the character string that exists in the last line below the start character string of each category is set to be the end character string for the start character string in question. Thus, even if the same end character string is stored in different items, when a plurality of end character strings exist in the payment transaction print data, a plurality of image data are never printed in a manner to overlap with each other.

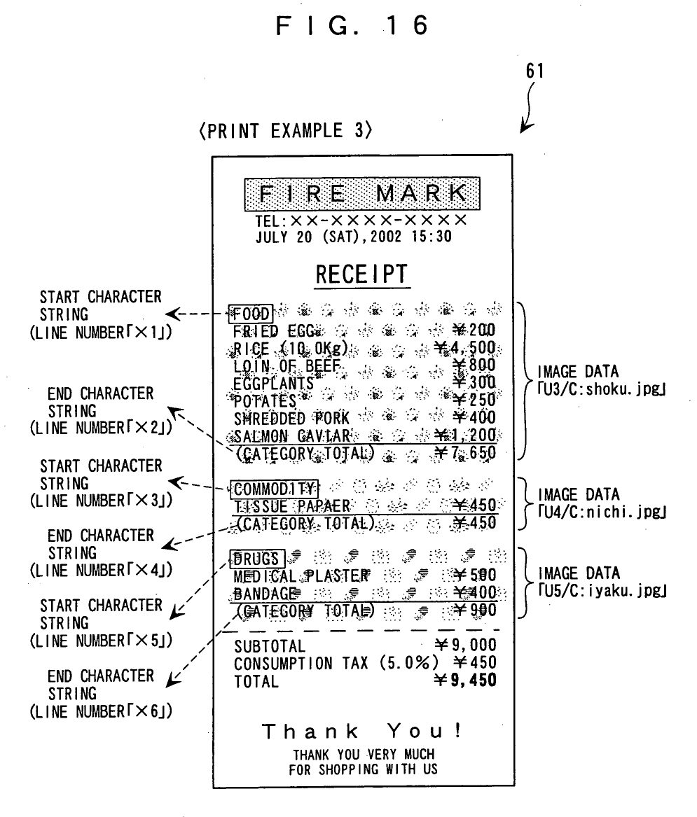

Now, the print result in the case of transmitting the image addition setting command shown in FIG. 12B is shown in FIG. 16. As shown in FIG. 16, the image data “U3/C:syoku.jpg”, “U4/C:nichi.jpg” and “U5/C:iyaku.jpg” are printed in the print regions specified by the respective start character strings and end character strings. Moreover, even if the end character strings are the same with one another, since a plurality of the end character strings exist in the payment transaction print data, the three image data are never printed while overlapping with each other.

In the above-described manner, even in case where a plurality of image designation data are printed in different print regions as shown in <Print Example 3>, it is possible to perform the addition setting of the image data by using one image addition setting command.

As described above, the present invention is a printing apparatus and a printing method in which a predetermined character string(s) is searched from the payment transaction print data; the position(s) of the character string(s) is specified by obtaining the information substantially specifying the position on the receipt of the data as printed thereon; the start point and/or the end point on the receipt of the image data is determined by using the information about the character strings; the receipt print data are generated by synthesizing the payment transaction data and the image data together; and the generated receipt print data are printed.

According to the preferred embodiment, the image designation data, the start character string and the end character string are associated with each other and are stored in a plurality of numbers as the definition table. Thus, in accordance with the character strings included in the payment transaction print data, it is possible to print a variety of image data in desired print regions.

Particularly, in the case of using the printing apparatus 50 of the present invention in the POS system 10 as described in the embodiment, by previously storing a logo of a store and the like as the image data, it is possible to issue the receipt 61 on which the logo of the store is printed in a specific region. Specifically, only by providing the printing apparatus 50 used as a receipt printing apparatus with a small memory for storing the image data (the logo), it is possible to create a receipt with high visibility and to improve an advertising effect by making strong impression of the store's image to the customers.

In the foregoing embodiment, the generation of the image addition setting command is realized by the printer driver 109 installed in the control unit 140 inside the PC 40. However, this function may be stored in a recording medium so that a generation program can be utilized by other PCs and printing apparatuses. The recording medium usable herein includes a hard disk, a flash ROM, a memory card (such as Compact Flash (trademark), Smart Media (trademark) or Memory Stick (trademark)), a compact disk, a magneto-optical disk, a digital versatile disk, a flexible disk and the like.

As described above, according to the method of controlling a printing apparatus of the present invention, the method of generating receipt print data, the program, the printer driver, the printing apparatus, the merchandise sales data processing apparatus, and the POS system, the image data are not transmitted to the printing apparatus 50 from the PC 40, but the image data are stored in the printing apparatus 50 in advance, and the image addition setting command for adding the image data is transmitted from the PC 40. Thus, even if the low-speed interface is used as the interface between the PC 40 and the printing apparatus, a transmission time poses no problem and processing efficiency is not lowered.

Moreover, the printing apparatus 50 obtains the line numbers from the parameters included in the image addition setting command and thus exerts various operations and effects such as capability of specifying the print position easily, or capability of producing a good-looking receipt as a consequence.

Furthermore, the image addition setting command for adding the image data is generated by the printer driver 109 and thus it is possible to set the image data by the PC 40 without directly operating the printing apparatus 50. In addition, it is possible to issue a color-graphic-based receipt by using the printing apparatus 50 without changing an application program even if the PC 40 uses a monochrome-text-based application program.

In the foregoing example, the payment transaction print data are previously set to be printed in the primary color “K (black)” and the image data can be set to be printed in the print color other than “K (black)” (the secondary color). Here, it is also possible to set “K (black)” as the print color for the image data. However, in this case (when the print colors for the payment transaction print data and the image data are set to the same color), it is preferable that the brightness for printing the image data is automatically set to be lower. According to the arrangement described above, it is possible to add the image data without making it difficult to read the payment transaction print data.

Moreover, in addition to the image data, the print color of the payment transaction print data may be arranged to be selectable. However, in this case as well, it is preferable that the print color for the image data is set only to the color which is different from the color selected for printing the payment transaction print data. Alternatively, when the print color for the payment transaction print data and the print color for the image data are set to be the same color, it is preferable that the brightness for printing the image data is automatically set to be lower.

A description has been made in the above examples based on the assumption that both of the start character string and the end character string are preset. However, even if any of these character strings is not preset, it is possible to specify the print region for the image data in accordance with a default value. For example, when the start character string is not designated, it is possible to start printing the image data from the line located in a certain length X away from the top end of the receipt 61. Similarly, when the end character string is not designated, it is possible to end printing the image data at the line located in a certain length Y away from the bottom end of the receipt 61. Alternatively, when the start character string is not designated, it is possible to start printing of the image data from the line where a certain character string included in the payment transaction print data (such as “TEL:”) is printed. When the end character string is not designated, it is possible to end printing of the image data at the line where another certain character string included in the print data (such as “Thank you very much for shopping with us”) is printed. According to the arrangement described above, it is possible to save the labor for setting when the user does not care about the print region.

Moreover, the contents of setting the image data (the definition table) are not limited to the items illustrated in FIG. 6. It is also possible to provide facilities for setting scaling up/down or a rotation angle of the image data, designation of two or more image data and setting of the print colors for those image data. According to the arrangement described above, it is possible to add more diversified image data.

In the above-described examples, the receipt is prepared by superposing the image data on the payment transaction print data, i.e., by adding the background image to the payment transaction print data. The present invention is not limited to the above, but may be used in a case in which a campaign message, for example, is used as the image data for insertion into the payment transaction information. In this case, this insertion can be easily materialized by adding to the image addition setting command a given parameter for selecting the printing processing between “insertion” and “superposition.”

Furthermore, an inkjet printing apparatus is applied to the printing apparatus 50 in the above-described examples. However, it is also possible to apply a thermal head printing method or a wire dot printing method instead.

In addition, the present invention is not always limited to the above-described case using the POS system. Various modifications are possible within the scope of the present invention in terms of the system arrangement or apparatus arrangement. Accordingly, the present invention is also applicable to a stand-alone electronic cash register (ECR) without connection to a server, for example.

As described above, according to the method of controlling a printing apparatus of the present invention, the method of generating receipt print data, the program, the printer driver, the printing apparatus, the merchandise sales data processing apparatus and the POS system, the image data are not transmitted from the host computer by previously storing the image data in the host computer, but the image data are stored in the printing apparatus in advance and the image addition setting command for adding the image data is transmitted from the host computer. Thus, even if the low-speed interface is used as the interface between the host computer and the printing apparatus, there can be obtained an effect such as capability of rapidly printing the image data.

The entire disclosure of Japanese Patent Application Nos. 2002-298994 filed Oct. 11, 2002 and 2002-298995 filed Oct. 11, 2002 are incorporated by reference.

1. A method of controlling a printing apparatus which prints payment transaction print data generated on a basis of input information concerning merchandise sales with addition of predetermined image data, said method comprising the steps of:
obtaining the payment transaction print data;
retrieving a predetermined character string indicative of a print position of the image data to be printed from the payment transaction print data;
obtaining a line number specified by the retrieved predetermined character string;
adding the image data to the payment transaction print data based on the obtained line number so as to print the image data with a position specified by the line number serving as a reference, thereby obtaining a synthesized print result.

2. The method according to claim 1, further comprising the steps of:
generating an image addition setting command based on the obtained line number; and
transmitting the payment transaction print data and the image addition setting command to the printing apparatus;
wherein the printing apparatus adds the image data to the payment transaction print data based on a result of analysis of the image addition setting command.

3. The method according to claim 2, wherein the predetermined character string is a start character string indicative of a position to start addition of the image data; and
wherein, in the step of obtaining the line number, a line number specified by the start character string is obtained.

4. The method according to claim 2, wherein the predetermined character string is made up of a start character string indicative of a position to start addition of the image data, and an end character string indicative of a position to end addition of the image data;
wherein, in the step of obtaining the line number, a plurality of line numbers to be specified by the start character string and by the end character string are obtained.

5. The method according to claim 4, wherein the printing apparatus has stored therein a plurality of image data files which are files of the image data, the method further comprising the steps of:
storing a definition table in which the start character string and the end character string are correlated with image designation data for designating an image data file out of a plurality of image data files stored in the printing apparatus; and
obtaining, from the definition table, image designation data which are related to the extracted start character string and the end character string,
wherein, in the step of generating the image addition setting command, the image addition setting command is generated on the basis of the obtained line number and the image designation data.

6. The method according to claim 4, further comprising the step of setting at least one of the start character string and the end character string.

7. The method according to claim 6, further comprising the step of setting image designation data in which the image designation data are set in correlation with at least one of the start character string and the end character string to be set in the step of setting the character string.

8. The method according to claim 4, further comprising the step of setting the line number in which, in the step of obtaining the line number, setting is made as to which is obtained between the line number in the start character string and the line number which is one line below the start character string, and setting is made as to which is obtained between the line number in the end character string and the line number which is one line above the end character string.

9. The method according to claim 2 in which, in case the printing apparatus is capable of performing color printing, the method further comprises the step of setting a printing color of the image data, wherein the image addition setting command includes a parameter showing the printing color.

10. A method of generating receipt print data by adding stored image data to payment transaction print data generated by a host computer based on input information concerning merchandise sales, the method comprising the steps of:
storing the image data;
obtaining the payment transaction print data from the host computer;
obtaining from the host computer an image addition setting command for printing with the image data being added;
analyzing the image addition setting command to thereby obtain a line number indicative of a print position of the image data; and
generating the receipt print data for printing with the image data being added to the payment transaction print data based on the line numbers.

11. A program for executing the steps of the method of controlling a printing apparatus according to claim 1.

12. A printer driver for enabling a computer to execute the steps of the method of controlling a printing apparatus according to claim 1.

13. A printing apparatus to generate receipt print data by adding image data to payment transaction print data generated by a host computer based on input information concerning merchandise sales, the printing apparatus comprising:
means for storing the image data;
means for obtaining the payment transaction print data from the host computer;
means for obtaining from the host computer an image addition setting command for printing with the image data being added;
means for analyzing the image addition setting command to thereby obtain a line number indicative of a print position of the image data; and
means for generating the receipt print data by adding the image data to the payment transaction print data based on the line number.

14. The printing apparatus according to claim 13, further comprising:
means for performing color printing by using a primary color and at least one secondary color other than the primary color,
wherein the means for performing color printing prints the payment transaction print data in the primary color and the image data in said at least one secondary color.

15. A merchandise sales data processing apparatus having: the printing apparatus according to claim 13; and a host computer which controls the printing apparatus by transmitting the payment transaction print data and the image addition setting command to the printing apparatus,
wherein the host computer comprises:
means for generating the payment transaction print data;
means for retrieving a predetermined character string indicative of a print position of the image data to be printed from the payment transaction print data;
means for obtaining the line number specified by the extracted predetermined character string;
means for generating the image addition setting command based on the obtained line number; and
means for transmitting the payment transaction print data and the image addition setting command to the printing apparatus.

16. A POS system comprising:
the merchandise sales data processing apparatus according to claim 15; and
a POS server for managing the merchandise sales data processing apparatus, the POS server being connected to the merchandise sales data processing apparatus through a network.

17. A program the steps of the method of generating receipt print data according to claim 10.
